(19) United States
(12) Patent Application Publication
(10) Pub. No.: US 2008/0280564 A1
(43) Pub. Date: Nov. 13, 2008

(54) LOCATION ESTIMATION IN END-USER DEVICES USING PUBLIC RADIO SIGNALS

(76) Inventors: Geert Jan Hoekstra, Amersfoort (NL); Hendrik Bernard Meeuwissen, Huizen (NL)

Correspondence Address: CARLSON, GASKEY & OLDS, P.C./Alcatel-Lucent, 400 W MAPLE RD, SUITE 350, BIRMINGHAM, MI, 48009, US

(21) Appl. No.: 11/747,422

(22) Filed: May 11, 2007

(51) Int. Cl. G01S 5/02; H04B 7/00

(52) U.S. Cl. 455/66.1

(57) ABSTRACT

A device (20) is capable of making location determinations from publicly available broadcasting signals that contain programming such as radio or television programming. A location estimating portion (26) in one example uses a determined received power of a detected signal from a transmitter and information regarding the location and transmit power of the transmitter for determining a distance between the device (20) and the known location of the transmitter. At least one other location indicator is used for making a determination regarding the location of the device (20). In one example, the other location indicator is a determined distance between the device and at least one other transmitter, which is based upon a determined received power of a signal from the other transmitter and the transmit power used by that transmitter. Another example includes determining where the coverage areas of a plurality of transmitters overlap as an indication of the location of the device (20). In one example, the coverage areas and identities of the transmitters are determined based upon the carrier frequencies of a plurality of detected signals.

### FIELD OF THE INVENTION

This invention generally relates to location determination. More particularly, this invention relates to using radio signals for location determination.

### DESCRIPTION OF THE RELATED ART

With the miniaturization of electronics, it has become increasingly popular to use portable electronic devices for a variety of purposes. For example, cell phones are increasingly used for voice and data communications. Personal digital assistants and notebook computers have increasing wireless communication capabilities. Other devices such as music or video players and televisions are now commonly available in small enough sizes to be carried about conveniently.

There are a variety of situations for which a location estimation would be useful when using such devices. For example, it may be useful to obtain weather forecast information, traffic information or regional activity information and to be able to use a portable electronic device for that purpose. While the variety of uses for location information with such devices is increasing, the availability of such information is relatively limited.

For example, not all cell phones have on-device location estimation capabilities. Only some cell phones include global positioning system (GPS) location capabilities. GPS devices typically do not provide features other than those directly related to GPS location information. Portable music or video players typically do not have any location capabilities even though they would be capable of providing an output indicating the location information if that could be obtained with such a device.

Additionally, even devices that have location capabilities are not able to obtain sufficient signals for location information in a variety of circumstances. GPS receivers may not always be able to detect a sufficient number of satellites for making GEO-location determinations, for example. This is particularly true inside buildings where GPS satellite signals are often undetectable or if they are available, they are limited to only one or two satellites because GPS location ideally requires a clear view of the sky.

It would be useful to provide enhanced location capabilities that could be incorporated into a variety of portable devices. It would also be beneficial if such capabilities allowed for determining a location in an anonymous manner.

### SUMMARY

An exemplary method of locating a portable device includes detecting a signal from a transmitter that broadcasts publicly available programming. The transmitter has a known location and uses a known transmit power for transmitting the signal on a known carrier frequency. A received power of the detected signal is determined. A distance range between the radio receiver and the location of the transmitter is determined from the received power and the known transmit power at the carrier frequency of the detected signal. A location of the radio receiver is determined based on the determined distance range and at least one other location indicator.

Another exemplary method of locating a portable device includes detecting a plurality of signals from a plurality of transmitters that each broadcasts publicly available programming. Each transmitter has a known location and uses a known carrier frequency for transmitting its signal. Each of the stations corresponding to the detected signals is identified from at least one characteristic of the corresponding detected signal. An area in which the coverage of all of the identified transmitters overlaps is determined and used as an indicator of a location of the portable device.

The various features and advantages of disclosed example embodiments will become apparent to those skilled in the art from the following detailed description. The drawings that accompany the detailed description can be briefly described as follows.

### BRIEF DESCRIPTION OF THE DRAWINGS

FIG. 1 schematically illustrates a portable electronic device that is useful with an embodiment of this invention.

FIG. 2 is a flowchart diagram summarizing one example approach.

FIG. 3 schematically illustrates a location determination technique used in one example.

FIG. 4 is a flowchart diagram summarizing another example approach.

FIG. 5 schematically illustrates another example location determination technique.

FIG. 6 schematically illustrates another example technique.

### DETAILED DESCRIPTION

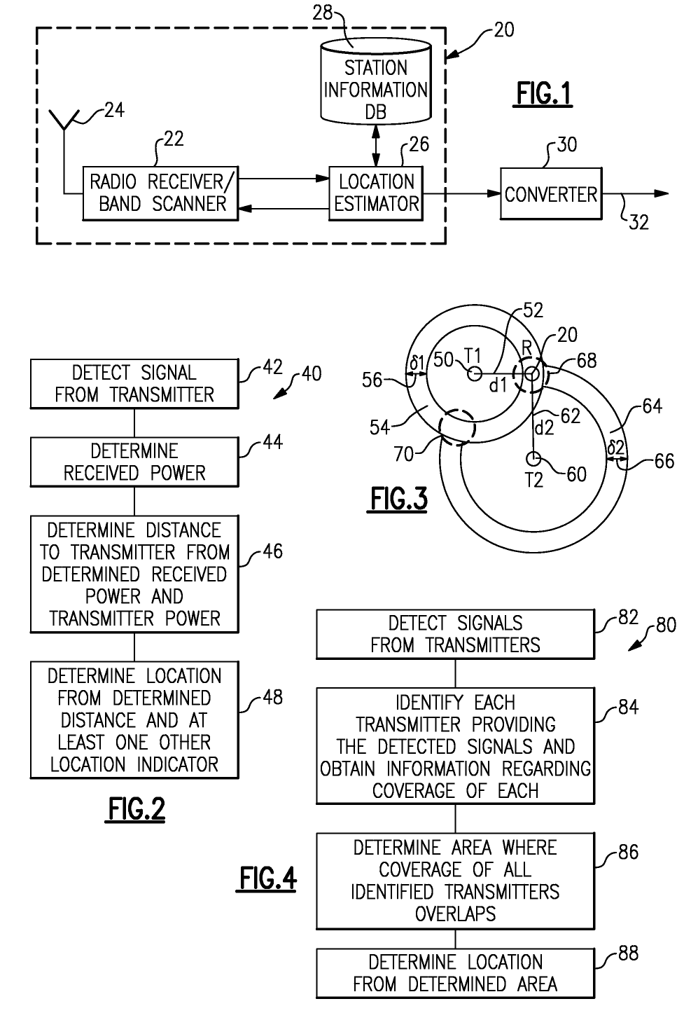

FIG. 1 schematically shows a portable device 20 having location capability for determining a location of the device. A receiver portion 22 detects signals that are available to an antenna 24. In one example, the detected signals comprise publicly broadcast programming such as radio or television programming signals. A location estimator portion 26 uses information regarding the at least one detected signal from the receiver portion 22 for making a determination regarding the location of the device 20. The illustrated example includes a database portion 28 that includes information that is useful in conjunction with information from a detected signal for making a location determination.

The example of FIG. 1 also includes a converter portion 30 that converts a determination made by the location estimator portion 26 into an output 32 of a desired configuration. For example, the determined location information may be provided as geographic coordinates (e.g., longitude and latitude), a street address, a postal code, a city name or another geographic indicator.

The example device 20 is useful for a variety of situations where location information may benefit the user of an electronic device. By detecting publicly available programming signals using the receiver portion 22, the device 20 allows for anonymously making a location determination regarding the device 20 and any other electronics associated with it. For example, the device 20 may be incorporated into a cell phone, notebook computer, portable music or video player or a personal digital assistant. The device 20 may also be a stand alone device. Given this description, those skilled in the art will realize in what situations and with what type of devices, the location capabilities of the example device 20 will be beneficial.

FIG. 2 includes a flowchart diagram 40 that summarizes one example approach for making a location determination using a device like the device 20 of FIG. 1. This example allows for anonymous location determinations because they can be completed on the device using publicly broadcast signals. At 42, at least one signal is detected from a transmitter. In one example, the transmitter broadcasts publicly available programming such as radio or television programming. The transmitter has a known location and uses a known transmit power for providing the signal. The transmitter also uses a known carrier frequency for providing the signal. In one example, the database 28 includes information regarding a plurality of such transmitters such that the location, transmit power, carrier frequency or any combination of them is available to the location estimator portion 26 for purposes of making a location determination. In one example, the location estimator portion 26 populates the database 28 based upon radio data system information obtained regarding transmitters from which signals are detected. At 44, the received power of the detected signal is determined. There are a variety of techniques for determining the power of a received signal that are known, which are useful in an embodiment of a device like the device 20 of FIG. 1.

At 46, a distance range between the device 20 and the transmitter is determined based upon the determined received power and the transmit power that is used by the transmitter for providing the detected signal. Known techniques for determining distances based upon transmit power and received power are used in one example. Once the distance range between the device 20 and the transmitter is determined, a location determination is made at 48 based upon the determined distance range and at least one other location indicator.

FIG. 3 schematically illustrates a location technique that is consistent with the approach of FIG. 2. In this example, the device 20 detects a signal from a first transmitter 50. The device 20 determines the received power of the detected signal and gathers information regarding the transmit power of the first transmitter 50. Based upon the received power and transmit power, the location estimator portion 26 makes a determination regarding a distance range between the device 20 and the first transmitter 50. As schematically shown in FIG. 3, the received power and transmit power provide information for computing a distance d1 between the device 20 and the transmitter 50. The distance d1 provides a radius 52 that establishes a potential location circle having the transmitter 50 at the origin of the circle.

The illustrated example uses a distance range schematically shown as a ring 54 that is based on the determined distance d1. The ring 54 includes a tolerance 56 that establishes a band encompassing the distance d1 at all possible locations of the device 20 relative to the transmitter 50. In this example, the radius 52 extends between the known location of the first transmitter 50 and the center of the ring 54. The tolerance 56 will depend upon the type of receiver in the device 20, the type of received signal, the quality of the received signal or a combination of them, for example. Given this description, those skilled in the art will understand how to determine an appropriate tolerance band that allows them to determine a distance range that meets the needs of their particular situation.

For most situations, determining a potential location of the device 20 within the distance range ring 54 will not prove satisfactory as it is a relatively large set of potential locations. In the example of FIG. 3, at least one other location indicator is used. In this example, a detected signal from a second transmitter 60 provides another location indicator. The device 20 determines a received power of the signal detected from the second transmitter 60. The device 20 also gathers the appropriate information (e.g., from the database 28 assuming it is pre-populated with such information) regarding the location of the second transmitter 60, the transmit power of the second transmitter 60 and the carrier frequency of the detected signal. In this example, the determined received power and the transmit power are used for calculating a distance d2 between the device 20 and the known location of the second transmitter 60. The distance d2 provides a radius 62 that establishes a second circle, which is a basis for a second distance range schematically shown as a ring 64. The second distance range ring 64 includes potential locations for the device 20 relative to the second transmitter 60. In this example, the ring 64 has a width defined by a tolerance 66 that is similar to the tolerance 56.

In this example, the location estimating portion 26 determines what locations within the possible locations of the illustrated distance range rings 54 and 64 match. There is a match in possible locations based upon the determined distance ranges 54 and 64 as shown where the illustrated rings overlap. In the illustrated example, there are two potential locations shown at 68 and 70, respectively. In the illustration, the device 20 is actually located within the potential location 68.

If at least one more signal is detected from at least one more transmitter, the potential locations of the device 20 are further narrowed. Given a plurality of additional transmitter locations and determined distances between the device 20 and those transmitters, the location of the device 20 may be further refined. As the number of detectable signals and known transmitter locations increases, the estimate of the location of the device 20 becomes more accurate.

FIG. 4 includes a flowchart diagram 80 that summarizes another example approach. At 82, a plurality of signals is detected from a plurality of transmitters. In one example, each of the transmitters broadcasts publicly available programming such as radio or television programming. An identity of each transmitter is determined at 84. The coverage area of each transmitter can be known once each transmitter is identified. In one example, the database 26 is populated with information regarding a plurality of transmitters, their identities, locations and estimated coverage areas for signals transmitted by each transmitter.

In one example, the identity of each transmitter is determined based upon the carrier frequency of the detected signal. Another example includes using radio data system information that can be obtained by demodulating the detected signal. Once the transmitter is identified, it is possible to obtain information regarding the transmitter's location coordinates and coverage area information.

At 86, a determination is made regarding an area where the coverages of all identified transmitters overlap. At 88, the location of the device 20 is determined from the determined area where the coverages overlap.

Given information regarding the coverage areas, the location estimator portion 26 is suitably programmed to make a determination where those coverage areas overlap and to determine geographic information regarding the boundaries of that overlap area such as GEO-location coordinates (e.g., longitude and latitude).

In one example, the determined location is based upon an estimate of a center of the determined area. One such example includes providing an indication of a likely accuracy of the location estimate. For example, if the determined area covers one square kilometer, the likely accuracy indication would be within about one-half of a kilometer. In another example, the determined location is based upon a description of the area, which may comprise a plurality of coordinates that define an outer boundary of the area, for example.

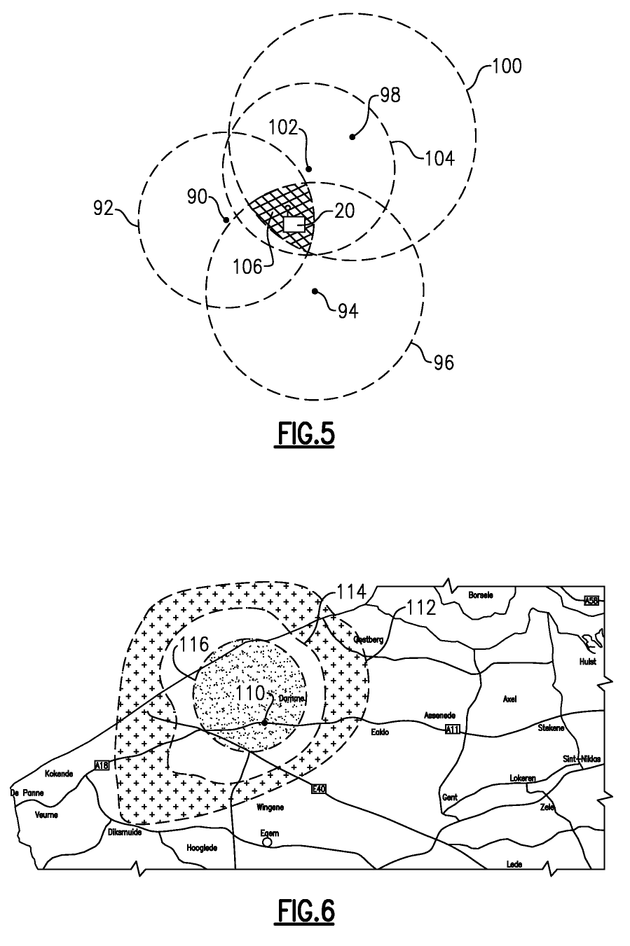

FIG. 5 schematically shows a location determination that is consistent with the example of FIG. 4. In FIG. 5, a device 20 detects a signal from a first transmitter 90 that has a corresponding coverage area 92. Another signal is detected from a transmitter 94 having a corresponding coverage area 96, a transmitter 98 having a corresponding coverage area 100 and a transmitter 102 having a corresponding coverage area 104. Based upon information regarding each of the coverage areas 92, 96, 100 and 104, the location estimator portion 26 of the device 20 determines the boundaries of the area shown at 106 in FIG. 5. The area 106 is used for determining the location of the device 20. As more signals can be detected from more transmitters, the scope or range of the area 106 will become increasingly narrowed and provides more accurate location information.

FIG. 6 schematically shows another technique useful with the embodiment of FIG. 5 for providing potentially more accurate location information. In FIG. 6, a transmitter 110 has a maximum likely coverage area within the boundary 112. The quality of the signal available to a receiver within the area encompassed by the boundary 112 will not be consistent throughout that area. Closer to the transmitter 110, the signal quality will be better compared to what is available at locations further away from the transmitter 110. The example of FIG. 6 includes using at least one quality indicator regarding the detected signal for determining where the device 20 is likely located within the area encompassed by the boundary 112.

In FIG. 6, three different ranges within the total coverage of the transmitter 110 are shown. One boundary 114 establishes a boundary between an outer region (e.g., between the boundaries 112 and 114) where a signal quality characteristic is discernibly different and of lower quality than it is in another region on the inside of the boundary 114. Another boundary 116 establishes an area within which the signal quality characteristic is discernibly different than it would be in the area between the boundaries 114 and 116.

In one example, the signal quality characteristic comprises the type of information that can be obtained from the signal. In an FM radio signal, for example, the region within the boundary 116 corresponds to an area where a perfect stereo reception is possible. The area between the boundaries 116 and 114 corresponds to locations where a noiseless signal is available but stereo is not available or at least not consistently available. The area between the boundaries 114 and 112 corresponds to locations where no stereo reception is possible while noise may be audible. One example includes adding another level of discernment corresponding to an area where no good mono reception is possible, which would be a portion of the area between the boundaries 112 and 114 but closer to the boundary 112, for example.

Another example includes establishing ranges within the coverage area that correspond to signal-to-noise ratios of the received signal. Another example includes using a different signal quality level indicator. Using a signal quality characteristic allows for reducing the likely area within which the device 20 is located because an entire coverage area of a transmitter need not be considered. Reducing the possible location area allows for more accurately determining the location of the device 20.

The number of transmitters used for the techniques of FIGS. 2-5 may be limited by setting a threshold on an appropriate characteristic of a detected signal for determining whether the corresponding transmitter will be included in a location estimation. One example includes setting a threshold for the received signal strength while another example includes setting a threshold for the signal-to-noise ratio. Still another example includes using the determined received power and a corresponding threshold for determining which detected signals will be used for a location determination.

Information within the database 28 may be stored on a memory device such as a SDRAM memory card. Information for the database may be obtained as needed by downloading information from the Internet. In one example, a GPRS connection is used for obtaining such information. The database 28 may be stored and updated as often as needed depending on a particular situation. For example, when an individual knows they will be traveling to a particular location, they may download information regarding transmitters in that region for making location determinations while visiting that region. In some examples, the device 20 will have the ability to download such information on an as-needed basis. Additionally, local database information may be obtained from a local retailer of such information. Information for identifying the particular transmitters may be obtained from the detected signal where radio data system techniques are utilized by the transmitters. For example, program identification functions can be used to identify the transmitter, radio text functions may give transmitter location and address information and transparent data channel functions can be used as a data channel to receivers. In some instances, one transmitter will include information regarding other transmitters in the region. Another example includes dedicating one or more broadcasting stations to provide information regarding the identities and locations of transmitters in the area.

In one example, the transmitter identity is determined from the carrier frequency. The spectrum is scanned to find a list of frequencies at which transmitters are active. A database lookup yields corresponding identities. This technique is useful when a sufficient number of stations or transmitters are available. For example, a single carrier frequency used for the look-up limits the number of possible transmitters because only certain transmitters are allowed to transmit on that carrier frequency. Considering multiple carrier frequencies simultaneously allows for uniquely identifying or fingerprinting the transmitters. In some instances, a list of carrier frequencies will be sufficient to uniquely resolve all identifiers of all transmitters providing all detected signals. If the number of carrier frequencies used is reduced, it may not be possible to obtain unique identities. This approach to determining the identity of transmitters is analogous to solving a problem with N equations and M unknown variables.

In situations where unique identities cannot be established based only on the carrier frequencies, the identity of one or more transmitters may be obtained from radio data system information from at least one of the detected signals. Where enough such information is available, it will be possible to resolve most identification problems.

Another example approach combines selected features of the embodiments of FIGS. 2 and 4 (or FIGS. 3 and 5). In this example, the determined location is based on at least one determined distance range between the device 20 and a transmitter and a determined coverage area of at least one other transmitter. Using multiple determined distance ranges (e.g., 54 and 64) and multiple determined coverage areas (e.g., 92, 96, 100 and 104) allows for determining an area where the corresponding possible locations overlap. In one example the distance ranges from a plurality of transmitters are determined first. Then determining an area of coverage overlap of the same plurality of transmitters or other transmitters is used to narrow down the potential locations of the device 20. In another example, the area of coverage overlap is determined first, followed by determining some distance ranges to yield a more precise location determination.

One feature of the disclosed examples is that the device 20 can operate completely anonymously for making location determinations. In some situations, information for making a location determination may be necessary that has to be obtained in a way that removes the anonymity from the device. For most situations, however, complete anonymity is available to the user of the device 20.

The preceding description is exemplary rather than limiting in nature. Variations and modifications to the disclosed examples may become apparent to those skilled in the art that do not necessarily depart from the essence of this invention. The scope of legal protection given to this invention can only be determined by studying the following claims.

1. A method of locating a portable device comprising the steps of:
detecting a signal from a transmitter that broadcasts publicly available programming, the transmitter having a known location and a known transmit power used for transmitting the signal on a known carrier frequency;
characterized by
determining a received power of the detected signal;
determining a distance range between the device and the location of the transmitter from the determined received power and the transmit power; and
determining an area as an indicator of a location of the device based on the determined distance range and at least one other location indicator.

2. The method of claim 1, wherein the at least one other location indicator comprises a second distance range between the device and a second, different transmitter.

3. The method of claim 2, comprising
detecting a second signal from the second transmitter that broadcasts publicly available programming, the second transmitter having a known location and transmit power used for transmitting the signal on a known carrier frequency;
determining a received power of the second signal; and
determining the second distance range between the second transmitter and the device from the determined received power of the second signal and the transmit power of the second transmitter.

4. The method of claim 2, comprising
determining a first plurality of possible locations based upon the determined distance range between the device and the transmitter;
determining a second plurality of possible locations based upon the second distance range between the device and the second transmitter;
determining at least one location area where there is at least one of the first plurality of possible locations and at least one of the second plurality of possible locations; and
using the at least one determined location area as the determined area that is an indicator of the location of the device.

5. The method of claim 2, wherein the at least one other location indicator comprises another distance between the device and another, different transmitter.

6. The method of claim 1, comprising
determining the location and transmit power of the transmitter from at least one of
a database that includes transmitter location and transmit power information corresponding to each of a plurality of transmitters,
radio data system information available from the detected signal, or
information obtained from another signal available from a broadcasting station that provides such information regarding a plurality of transmitters.

7. The method of claim 1, comprising
detecting a plurality of signals from a plurality of transmitters, respectively, each of the plurality of transmitters having a known location, a known carrier frequency for transmitting the signal and a known coverage area within which the transmitter provides the signal;
identifying each of the transmitters corresponding to each of the detected signals from at least one characteristic of each detected signal;
determining an overlap area in which the coverage of all of the identified transmitters overlaps; and
using the determined overlap area for determining the area that is an indicator of the location of the device.

8. The method of claim 7, comprising
determining where the determined area and the determined overlap area coincide to provide the indicator of the location of the device.

9. A method of locating a portable device, comprising the steps of:
detecting a plurality of signals from a plurality of transmitters, respectively, each of the plurality of transmitters having a known location, a known carrier frequency for transmitting the signal and a known coverage area within which the transmitter provides the signal;
characterized by
identifying each of the transmitters corresponding to each of the detected signals from at least one characteristic of each detected signal;
determining an area in which the coverage of all of the identified transmitters overlaps; and
using the determined area as an indicator of the location of the device.

10. The method of claim 9, comprising
providing an indication of the location of the device based upon at least one location within the determined area.

11. The method of claim 10, comprising
providing an indication of a likely accuracy of the determined location.

12. The method of claim 9, comprising
providing an indication of a boundary around the determined area as an indication of the determined location.

13. The method of claim 12, comprising
providing geographic coordinates regarding a plurality of locations corresponding to the boundary of the determined area.

14. The method of claim 9, comprising
determining at least one signal quality characteristic of at least one of the detected signals; and
determining the coverage area of the transmitter of the at least one of the detected signals based upon the determined quality characteristic.

15. The method of claim 14, comprising
determining a plurality of ranges within a maximum coverage area of the corresponding transmitter, wherein the signal quality characteristic in each range is different than the signal quality characteristic in the other ranges; and
determining which of the plurality of ranges corresponds to a possible location of the device based upon the signal quality characteristic of the corresponding detected signal.

16. The method of claim 9, comprising
detecting a signal from a transmitter that broadcasts publicly available programming, the transmitter having a known location and a known transmit power used for transmitting the signal on a known carrier frequency;
determining a received power of the detected signal;
determining a distance range between the device and the location of the transmitter from the determined received power and the transmit power; and
providing the indicator of the location of the device based on the determined area, the determined distance range and the at least one other location indicator.

17. The method of claim 9, comprising
determining the location and coverage area of the transmitter from at least one of
a database that includes transmitter location and coverage area information corresponding to each of a plurality of transmitters,
radio data system information available from the detected signal,
information obtained from another signal available from a broadcasting station that provides such information regarding a plurality of transmitters.

18. A receiver device having an on-device location capability, comprising:
means for detecting a signal from a transmitter that broadcasts publicly available programming, the transmitter having a known location and a known transmit power used for transmitting the signal on a known carrier frequency;
characterized by
means for determining a received power of the detected signal;
means for determining a distance range between the device and the location of the transmitter from the determined received power and the transmit power; and
means for determining an area as an indicator of a location of the device based on the determined distance range and at least one other location indicator.
